(19) United States
(12) Patent Application Publication
(10) Pub. No.: US 2002/0007310 A1
(43) Pub. Date: Jan. 17, 2002

(54) Information appliance cost subsidy

(76) Inventor: Timothy Merrick Long, Lindfield (AU)

Correspondence Address: FITZPATRICK CELLA HARPER & SCINTO, 30 ROCKEFELLER PLAZA, NEW YORK, NY, 10112, US

(21) Appl. No.: 09/845,267

(22) Filed: May 1, 2001

(30) Foreign Application Priority Data
May 8, 2000 (AU) PQ7362

(51) Int. Cl. G06F 17/60

(52) U.S. Cl. 705/14

(57) ABSTRACT

A video information display business system is disclosed. In accordance with the system an information appliance (300) having an advertising display area (202) permanently disposed within a working display area (200) is provided. Advertising information is displayed in the advertising display area (202) and is not dependent upon a non-advertising application being run on the information appliance (300). The system comprises a software upgrade of the non-advertising application, the upgrade has an upgrade cost and is offered to an owner of the information appliance (300) for an upgrade price. The software upgrade has space for the advertising information. The system also comprises an advertising space cost determination means which is adapted to determine an advertising space cost for an amount of the space to be offered to an advertiser. The upgrade price determination means is adapted to determine the upgrade price dependent upon a difference between the advertising space cost and the upgrade cost. A price adjusting means is also provided and is adapted to adjust the advertising space cost in order to decrease the upgrade price.

### TECHNICAL FIELD OF THE INVENTION

The present invention relates generally to home and personal information appliances and, in particular, to their application to advertising. The present invention relates to video information display advertising, and a corresponding video information display business system. The invention also relates to a computer program product including a computer readable medium having recorded thereon a computer program for implementing the business system described above.

### BACKGROUND ART

The terms “Personal Data Assistant” (PDA) and “Home Information Appliance” (HIA) have, in recent times, become terms of increasingly common usage. A home information appliance is typically a device located in a domestic setting, providing household data processing and data storage functions. Examples of such functions include household calendars, reminders, household messages, rosters of chores, shopping lists, and World Wide Web queries relating to domestic issues. A personal data assistant is typically a mobile device owned by an individual, the device providing personal data processing and data storage functions. Examples of such functions include calendars, diaries, to-do lists, memos, and address books. In the present specification, the generic term “information appliance” has been used to denote a PDA, an HIA, or any other equivalent device with an information display.

A business model which is generally applied to both PDA and HIA devices is based upon a combination of revenue from (i) device sales, (ii) software upgrade sales, (iii) accessory sales, and (iv) on-line service subscription. This model, relating to items (i) to (iii), is predicated on the assumption that pricing for both devices and software is set at a level which generates profit on a per-sale basis. In relation to item (iv), the model assumes that wants and needs of a consumer are best satisfied by on-line services. In the context of this business model, the only practical methods of reducing cost to a consumer are to reduce the cost of manufacture, which typically implies reducing capabilities and features which are offered, and/or reducing the cost of distribution, which typically impacts negatively on the convenience of purchasing.

Turning, in particular, to software products, advertising has in some instances been used to generate an additional source of revenue. For example, advertising space on virtual advertising billboards which feature in three-dimensional sports games can be sold to advertisers. Such advertising suffers the limitation, however, of featuring only sporadically in the course of the video games, and of being significantly influenced by the video game user's particular activity profile. Accordingly, this source of additional revenue from software products has been rendered uncertain because advertisers are unsure of the effective advertising value thereof.

### DISCLOSURE OF THE INVENTION

It is an object of the present invention to substantially overcome, or at least ameliorate, one or more disadvantages of existing arrangements.

According to one aspect of the invention, there is provided an information appliance, comprising:

a display incorporating an advertising display area disposed within a working display area, wherein display of advertising information within said advertising display area is independent of a non-advertising application being run on the information appliance, and wherein upgrade software for upgrading said non-advertising application and for providing said advertising information, has an upgrade price for purchase by an owner of the information appliance, said upgrade price being dependent upon a difference between an advertising cost for an amount of said advertising display area and an upgrade cost for producing said upgrade software, and wherein said upgrade price is dependent on said advertising cost.

According to another aspect of the invention, there is provided an information appliance, comprising:

an advertising display area disposed within a working display area, wherein display of advertising information in said advertising display area is independent of a non-advertising application being run on the information appliance, said advertising information being disposed within the information appliance and said advertising display area being provided in the context of said non-advertising application, and wherein said information appliance has a terminal price for purchase by a consumer, said terminal price being dependent upon a difference between an advertising cost to an advertiser for an amount of said advertising display area and a manufacturing cost of said information appliance, said terminal price being dependent on said advertising cost.

According to still another aspect of the invention, there is provided a method of reducing a price of an information appliance having a display incorporating an advertising display area disposed within a working display area of the information appliance, said method comprising the steps of:

determining a manufacturing cost of the information appliance;

selling a portion of the advertising display area to an advertiser for an advertising cost;

determining a terminal price dependent upon a difference between said advertising cost and said information appliance manufacturing cost; and

adjusting said advertising cost to decrease said terminal price.

According to still another aspect of the invention, there is provided a method of reducing a price of a software upgrade for an information appliance, said information appliance having a display incorporating an advertising display area disposed within a working display area of the display, said method comprising the steps of:

selling a first use of the advertising display area to a first advertiser for a first advertising cost, said first use being to display a first set of advertising material during a period commencing with a first use of the appliance by a user after purchase of the appliance, and terminating with a last use of the appliance by the user prior to installation of a software upgrade;

determining a development cost of the software upgrade;

selling a further use of the advertising display area to a further advertiser for a further advertising cost, said further use being to display a further set of advertising material during a period commencing with a first use of the appliance by a user after installation of the software upgrade, and terminating with a last use of the appliance by the user prior to installation of a further software upgrade;

determining a price of the software upgrade dependent upon a difference between at least one of (i) said first advertising cost and said further advertising cost, and (ii) said development cost; and

adjusting said further advertising cost to decrease said price of the software upgrade.

According to still another aspect of the invention, there is provided a method of providing, at a reduced cost to a consumer, a device with a display capable of displaying images stored in digital form, said method comprising steps of:

providing digital storage means in said device for storing advertisement information;

storing in said digital storage means advertisement information paid for by at least one advertiser;

configuring the device to at least display said advertising information; and

providing said device to said consumer at a cost subsidised by said advertising payment.

According to still another aspect of the invention, there is provided a method of providing, at no cost to a consumer, software upgrades to a device with a display capable of displaying images stored in digital form, said display incorporating an advertising display area disposed within a working display area of said display, said method comprising steps of:

developing upgrade software which is configured to provide advertising information;

selling a portion of said advertising display area to at least one advertiser; and

providing, free of charge, said upgrade software to consumers, said free of charge provision being subsidised by said selling of said portion of said advertising display area.

According to still another aspect of the invention, there is provided a method of providing software upgrades to a device configured to display advertisements independently of other functions of the device, said providing being at a reduced cost to a consumer, said method comprising steps of:

producing upgrade software which includes provision for advertising space;

selling said advertising space to at least one advertiser; and

providing said software upgrades to a consumer at cost subsidised by selling said advertising space.

According to still another aspect of the invention, there is provided a method of providing a software upgrade to a device configured to display an advertisement at all times the device is operational, said providing being at a reduced cost to a consumer, said method comprising steps of:

producing said upgrade software which is configured to provide advertisements for display on said device;

selling advertising time for display of said advertisement, to at least one advertiser; and

providing said software upgrade to a consumer at a cost subsidised by said advertising sale.

According to still another aspect of the invention, there is provided a computer readable medium having a program recorded thereon, said program comprising a plurality of software modules adapted for interactive operation on at least one computer platform, said program being adapted to reduce a price of a software upgrade for an information appliance, said program comprising:

first determining code for determining a development cost of the software upgrade, an advertising display area being disposed within a working display area of the information appliance;

selling code for selling a portion of the advertising display area to an advertiser for an advertising cost;

second determining code for determining a price of the software upgrade dependent upon a difference between said advertising cost and said development cost; and

adjusting code for adjusting said advertising cost to decrease said price of the software upgrade.

According to still another aspect of the invention, there is provided a computer readable medium having a program recorded thereon, said program comprising a plurality of software modules adapted for interactive operation on at least one computer platform, said program being configured to reduce a price of an information appliance, said program comprising:

first determining code for determining a manufacturing cost of the information appliance, an advertising display area being disposed within a working display area of the information appliance;

selling code for selling a portion of the advertising display area to an advertiser for an advertising cost;

second determining code for determining a terminal price dependent upon a difference between said advertising cost and said information appliance manufacturing cost; and

adjusting code for adjusting said advertising cost to decrease said terminal price.

According to still another aspect of the invention, there is provided a computer readable medium having a program recorded thereon, said program comprising a plurality of software modules adapted for interactive operation on at least one computer platform, said program adapted to providing, at a reduced cost to a consumer, a device with a display capable of displaying images stored in digital form, said program comprising:

first providing code for providing a digital storage area within said device for storing advertising information;

storing code for storing in said digital storage space advertisement information paid for by at least one advertiser;

configuring code for configuring the device to at least display said adverting information; and

second providing code for providing said device to said consumer at a cost subsidised by said advertising payment.

According to still another aspect of the invention, there is provided a computer readable medium having a program recorded thereon, said program comprising a plurality of software modules adapted for interactive operation on at least one computer platform, said program adapted to provide, at no cost to a consumer, software upgrades to a device with a display capable of displaying images stored in digital form, said program comprising:

developing code for developing upgrade software which is configured to provide advertising information;

selling code for selling said advertising display area for the display of said advertising information to at least one advertiser; and

providing code for providing, free of charge, said software upgrade to consumers, said free of charge provision being subsidised by said selling of said advertising display area.

According to still another aspect of the invention, there is provided a computer readable medium having a program recorded thereon, said program comprising a plurality of software modules adapted for interactive operation on at least one computer platform, said program adapted to provide software upgrades to a device configured to display advertisements independently of other functions of the device, said providing being at a reduced cost to a consumer, said program comprising:

producing code for producing upgrade software which is configured to provide an advertising display area;

selling code for selling said advertising display area to at least one advertiser; and

providing code for providing said software upgrades to a consumer at a cost subsidised by said sale of said advertising display area.

According to still another aspect of the invention, there is provided a computer readable medium having a program recorded thereon, said program comprising a plurality of software modules adapted for interactive operation on at least one computer platform, said program adapted to provide a software upgrade to a device configured to display an advertisement at all times the device is operational, said providing being at a reduced cost to a consumer, said program comprising:

producing code for producing said upgrade software which is configured to provide an advertising display area;

selling code for selling said advertising display area to at least one advertiser; and

providing code for providing said software upgrade to a consumer at a cost subsidised by said sale of said advertising display area.

According to still another aspect of the invention, there is provided a method of determining a value for providing advertising space to an advertiser, said advertising space being part of an intended software upgrade for an information appliance which is one of a plurality of information appliances, said method comprising steps of:

determining a consumer exposure to current advertising in said plurality of information appliances; and

ascribing a value to said intended software upgrade dependent upon said consumer exposure.

According to still another aspect of the invention, there is provided a computer readable medium having a program recorded thereon, said program comprising a plurality of software modules adapted for interactive operation on at least one computer platform, said program adapted to determine a value for providing advertising space to an advertiser, said advertising space being part of an intended software upgrade for an information appliance which is one of a plurality of information appliances, said program comprising:

determining code for determining a consumer exposure to current advertising in said plurality of information appliances; and

ascribing code for ascribing a value to said intended software upgrade dependent upon said consumer exposure.

According to still another aspect of the invention, there is provided an information appliance comprising:

a video display having a working display area incorporating a reserved advertising display area disposed within the working display area, said reserved display area being adapted to display advertising information independently of a non-advertising application being run on the information appliance; and

input means adapted to accept a software upgrade for said non-advertising application, said software upgrade being configured to update advertising information, wherein said updated advertising information is displayed, independently of a non-advertising application being run on the information appliance, when said information appliance is operating.

According to still another aspect of the invention, there is provided a video information display business system for supplying an information appliance having a display incorporating an advertising display area disposed within a working display area, wherein display of advertising information within said advertising display area is independent of a non-advertising application being run on the information appliance, comprising:

upgrade software for upgrading said non-advertising application, said upgrade software having an upgrade cost and being offered to an owner of the information appliance for an upgrade price, said upgrade software being configured to provide said advertising information;

advertising cost determination means adapted to determine an advertising cost for an amount of said advertising display area to be offered to an advertiser;

upgrade price determination means adapted to determine said upgrade price dependent upon a difference between said advertising cost and said upgrade cost; and

price adjusting means adapted to adjust said advertising cost in order to decrease said upgrade price.

According to still another aspect of the invention, there is provided a video information display business system for selling an information appliance having an advertising display area disposed within a working display area, wherein display of advertising information within said advertising display area is independent of a non-advertising application being run on the information appliance, said advertising information being disposed within the information appliance and said advertising display area being provided in the context of said non-advertising application, comprising:

information appliance selling means for offering said information appliance to a consumer for a terminal price, said information appliance having a manufacturing cost;

advertising selling means adapted to offer an amount of said advertising display area to an advertiser for an advertising cost;

terminal price determination means adapted to determine said terminal price dependent upon a difference between said advertising cost and said manufacturing cost; and

price adjusting means adapted to adjust said advertising cost to decrease said terminal price.

### BRIEF DESCRIPTION OF THE DRAWINGS

A number of preferred embodiments of the present invention will now be described with reference to the drawings, in which:

FIG. 1 is a block diagram representation of an information appliance in accordance with a preferred embodiment of the present invention;

FIG. 2 depicts a permanent advertising display area reserved within a working display area of the terminal in FIG. 1;

FIG. 3 shows a block diagram representation of an information appliance in a second preferred embodiment;

FIG. 4 depicts an information appliance business system according to a preferred embodiment of the invention;

FIG. 5 shows a more abstract representation of the business system depicted in FIG. 4, emphasising the closely coupled interactive dependencies of system elements;

FIG. 6 shows a block diagram representation of a process for reducing a cost of an information appliance to a consumer;

FIG. 7 shows a block diagram representation of a process, according to the preferred embodiment, by which a price paid by a consumer for a software upgrade is minimised;

FIG. 8 is a schematic block diagram of a general purpose computer upon which the preferred embodiment of the present invention can be practiced;

FIG. 9 shows the home information appliance of FIG. 1;

FIG. 10 shows the information appliance of FIG. 9 having a bi-directional wireless link to the home computer; and

FIG. 11 is a flow chart showing a preferred negotiation process.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

In the context of this specification, the word “comprising” means “including principally but not necessarily solely” or “having” or “including” and not “consisting only of”. Variations of the word comprising, such as “comprise” and “comprises” have corresponding meanings.

The principles of the preferred method described herein have general applicability to information appliances. However, for ease of explanation, the steps of the preferred method are described with reference to a home information appliance. It is not intended that the present invention be limited to a home information appliance. For example, the invention may have application to a Personal Data Assistant or any other similar information appliance.

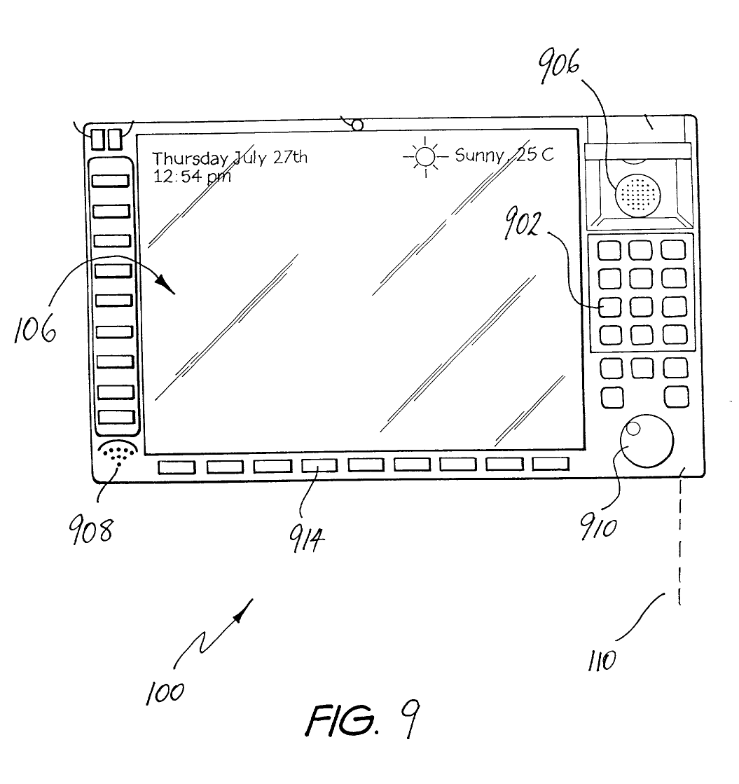

FIG. 9 shows a first embodiment of a home information appliance 100. The information appliance 100 of the first embodiment is a peripheral device which is preferably configured to be located where the typical household calender, message pad and/or shopping list would normally be located. The information appliance 100 preferably provides family messaging, calenders, shopping lists, radio, phone, clock, and other features. The preferred home information appliance 100 can be a self-contained information appliance capable of autonomous operation, or can make use of additional computing and storage resources located remotely, as will be described below.

The information appliance 100 comprises a generic keypad 902 for inputting data and other user information. The input data and user information are conveyed to the user via a display 106. In accordance with the first embodiment, the display 106 is a 640 by 480 pixel TFT LCD display. However, one skilled in the art would appreciate that any type of video or cathode ray tube (CRT) display can be used in accordance with the first embodiment. In one embodiment, the display 106 is a touch-screen so that the user can input data and change screens by touching the display 106. Audible user information can also be conveyed to the user via a speaker 906. In accordance with the first embodiment, the information appliance 100 also includes a generic dial 910 which can be used for adjusting the volume of audio output and for adjusting input data values. The information appliance 100 also includes a microphone 908 and voice recognition system (not shown) such that the user can input data and other user information audibly.

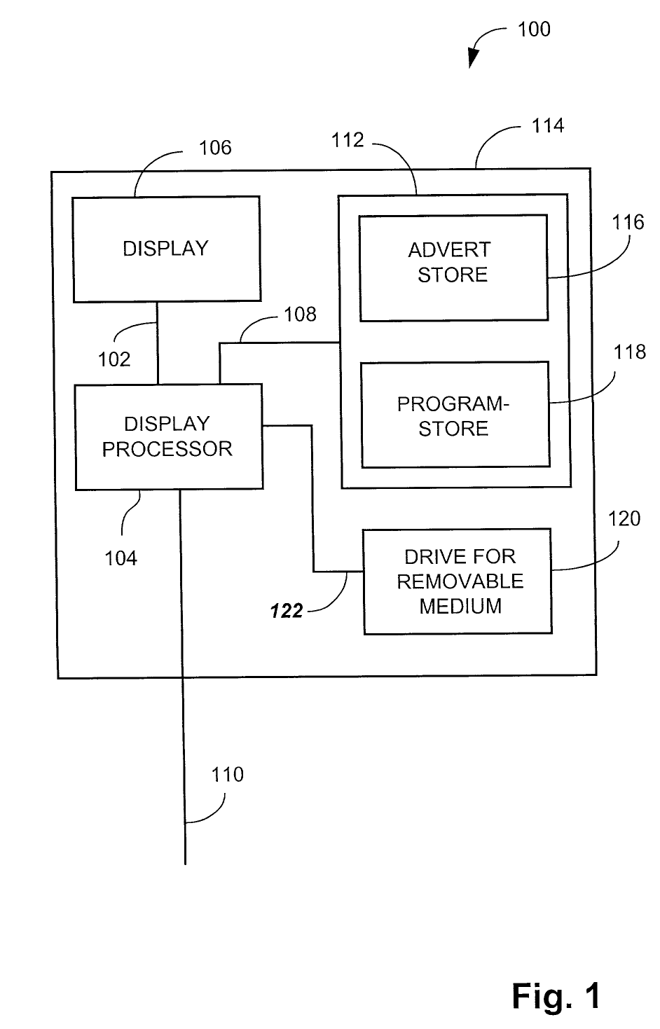

FIG. 1 is a schematic block diagram showing the data processing and storage configuration of the home information appliance 100 of the first embodiment. The information appliance 100 comprises a storage device 112 including a non-volatile memory 116 and a volatile memory 118. The information appliance 100 also comprises a processing unit 104 which operates in accordance with software applications (not shown) typically residing in storage 112.

In accordance with the first embodiment, at least part of the non-volatile storage 116 is reserved for advertising material information, preferably stored in the form of digital images such as “GIF” or Joint Picture Experts Group (JPEG) formatted images. The display 106 is connected to the display processor 104 by a connection 102, the display processor 104 accessing the external environment using the communication channel 110. The communication channel 110 may be in the form of a serial I/O port, a Universal Serial Bus (USB) data connection running either over a cabled connection, or alternatively, over a wireless link. The communication channel 110 is preferably connectable to any other processing device or network including a personal computer, a server, a computer network or a broad band radio network. The display processor 104 is connected to the storage device 112 by a connection 108, the storage device 112 comprising the aforementioned non-volatile storage 116 for advertising material, and a memory store 118, possibly volatile, which stores program applications and other non-advertising related data. The information appliance can also include a drive 120 for a removable medium, which is connected to the display processor 104, by a connection 122. The removable medium referred to can be either a floppy disc, a compact disc, or any one of the other commonly available removable storage media.

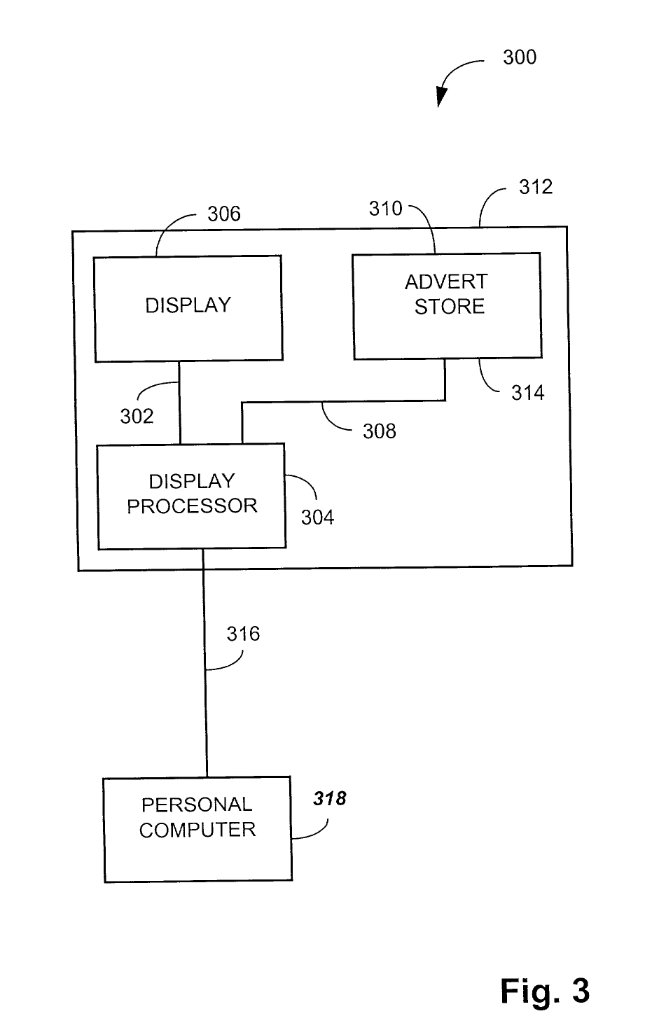

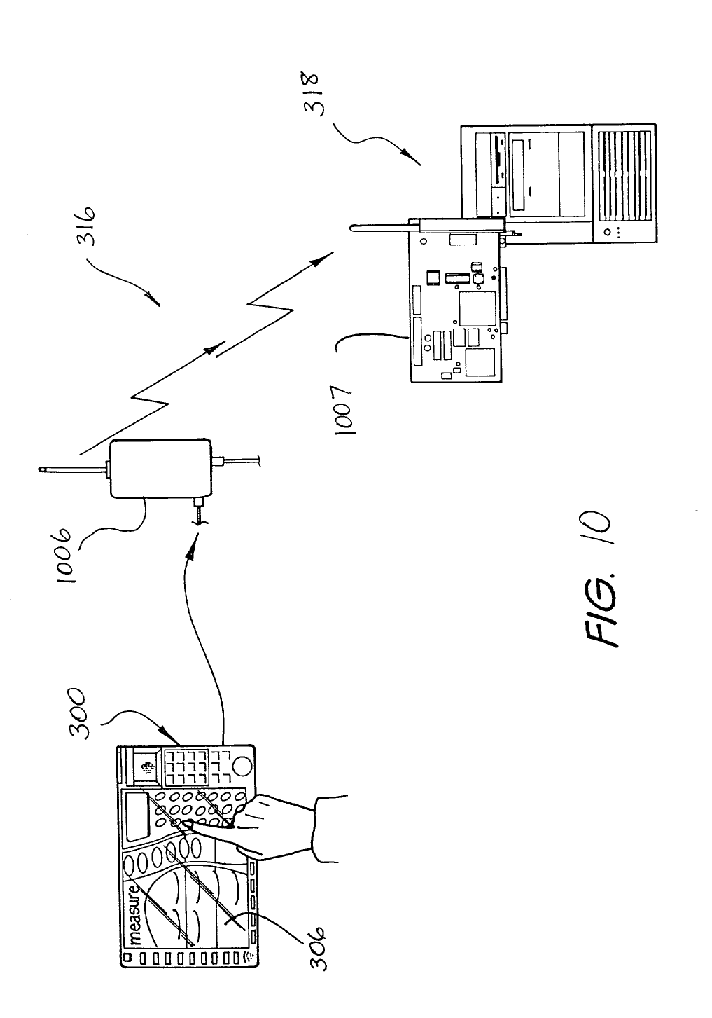

FIG. 3 shows a further embodiment of the present invention where a home information appliance 300, configured similarly to the information appliance 100 of FIG. 9, is situated in a convenient location in a particular domestic setting, and a remote PC 318 provides additional processing power and data storage. The information appliance 300 comprises a display unit 306 connected to a display processor 304 by a connection 302. The display processor 304 is connected to the remote PC 318 by a connection 316. The connection 316 can, for example, be implemented using a Universal Serial Bus (USB) data connection running either over a cabled connection, or alternatively, over a wireless link using radio frequency modems. FIG. 10 shows the information appliance 300 having a bi-directional wireless link 316 to the home computer 318. In accordance with the further embodiment of FIG. 10, the information appliance 300 can communicate, via the connection 316 in the form of a radio modem system 1006, 1007, with the remotely positioned home computer 318 providing processing power and data. The home computer 318 can in turn be used to access, for example, the Internet or Intranet in a conventional manner. The display processor 304 is connected to a non-volatile advertising storage device 310 by a connection 308. In this embodiment, the display console 300 can provide a large display with a reduced footprint. Since additional storage and processing requirements are relegated to the remote PC 318, additional flexibility is provided in supplying various desired physical configurations of the display console 300 to the market.

The information appliance 300 can be configured so that the user can input data or a command, using the information appliance 300 and the data or command is then transmitted to the home computer 318 for processing, via the connection 316. The information appliance 300 preferably comprises a number of user definable function buttons which can be configured to select any of a set of available applications running on an external processing device, such as the home computer 318. For example, a function button 914, as seen in FIG. 9, can be pre-configured to select a calculator application such that upon selection of the function button 914, a request is transmitted to the home computer 318. The home computer 318 receives the request and passes it to software. The home computer 318 activates a calculator application and draws a screen update. A frame difference is transmitted back to the information appliance 300, and a display on the information appliance 300 is updated. The user then uses the calculator application which is substantially executing in the computer 318 while being at the location of the information appliance 300.

The information appliance 100 can be utilised in a manner similar to the information appliance 300 described above. However, in the case of the information appliance 100, the calculator application or like application is stored in the program store 118 and executed by the display processor 104.

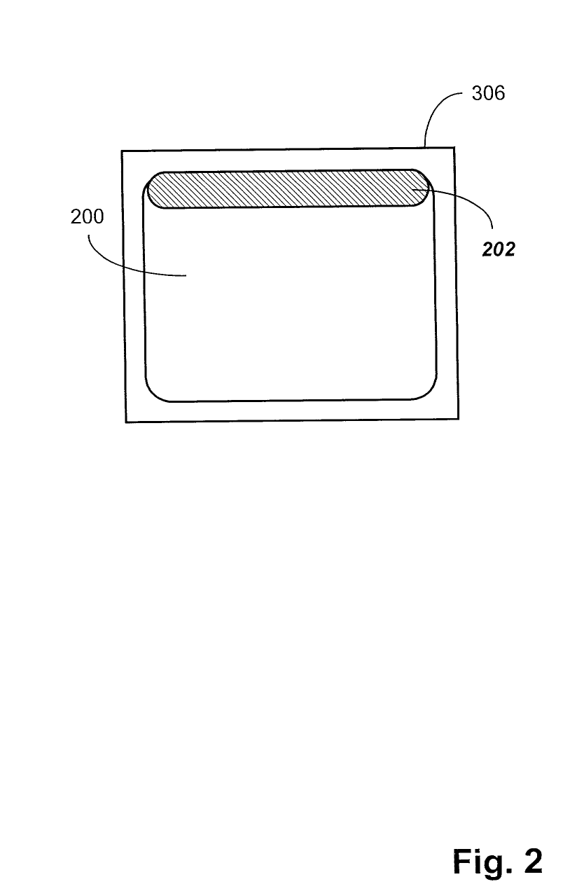

FIG. 2 shows the display 306 of the information appliance 300 in more detail, depicting a working display area 200, and an advertising display area 202 which is situated in an upper portion of the working display area 200. Again, the display area of the display 106 has a similar configuration with a working display area and advertising display area. The advertising display area 202 is permanently reserved for display of advertising material, the information appliance being configured to continuously display stored advertisements in the display area 202 in a pre-programmed, or pseudo random sequence as long as the information appliance is operational. Accordingly, the advertisements being displayed in the advertisement display area 202 become a permanent feature of the display aspect of the information appliance, not being in any way affected by any particular application which a user may run on the information appliance.

The advertising space 202 thereby created, is available for sale to advertisers, the extent of exposure provided being a function of the manner in which advertising material is displayed. The cost of this advertising space 202 can be estimated using normal advertising industry standards and criteria such as market reach, and market targeting. Furthermore, statistical market surveys of actual consumer exposure to the advertisements presented on the information appliance can be used to calibrate advertising cost, and to influence future software and hardware design.

In a preferred embodiment, advertising is sold on the basis of synchronised time periods. At the end of each time period, information appliance users are provided, by mail, with a CD-ROM containing upgraded software applications and new advertisements for the next advertising time period. This CD-ROM is loaded into the information appliance by insertion into the removable medium drive 120 (see FIG. 1). The cost at which the CD-ROM is supplied to the user is a function of a balance between (i) a cost of producing the upgraded software by the software developer, (ii) a profit margin required in this regard, and (iii) revenues achievable through sale of advertising space as previously described.

Other methods of delivering the software are possible, including direct electronic delivery over a communications network connected to the information appliance by the external communication channel 110 of FIG. 1 or the communication channel 316 of FIG. 2.

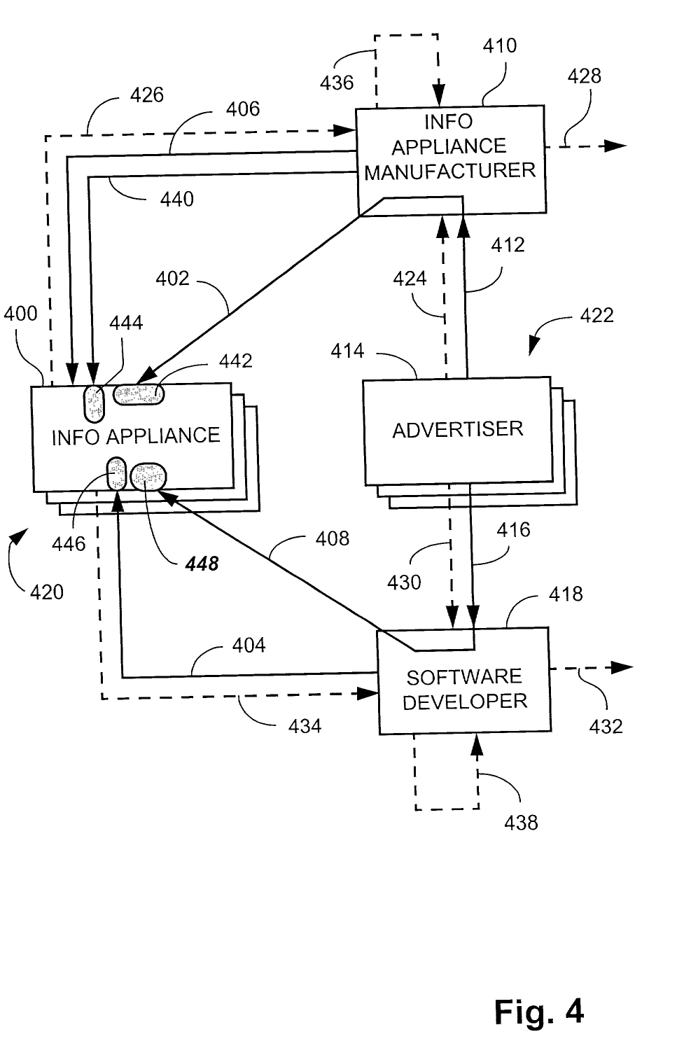

FIG. 4 shows a block representation of a video information display business system which embodies a business model balancing advertising revenues and a cost of both the information appliance device and its upgrade software. In the figure, an information appliance manufacturer 410 provides, possibly in conjunction with other information appliance manufacturers (not shown), a multitude of information appliances 420. A particular information appliance 400 is considered in the following description.

Each information appliance 400 has an associated cost, depicted by a dashed arrow 428, to the manufacturer 410. The information appliance manufacturer also makes a profit, as depicted by the re-entrant dashed arrow 436. The information appliance 400 is supplied with a software application 444 (the provision thereof being depicted by an arrow 440) to run the information appliance 400. An advertiser 414, one of many advertisers 422 in the market, pays the information appliance manufacturer 410 (the payment depicted by a dashed arrow 424) in exchange for advertising space in the initial software 444 of the information appliance 400 sold to a consumer (not shown). The supply of advertising material 442 (in accordance with advertising space purchased) to the information appliance manufacturer, and the incorporation thereof into the information appliance, is shown by the composite arrow segment 412-402.

The arrow segments 412, 402 thus represent delivery of the advertising 442 material by the advertiser 414 to the information appliance 400 via the manufacturer 410. The information appliance manufacturer 410, having loaded the advertising material 442 from the advertiser 414 as depicted by the arrow segment 412, supplies the information appliance 400 to the consumer as depicted by an arrow 406. The information appliance owner pays the information appliance manufacturer 410, the payment being depicted by a dashed arrow 426, for the purchase of the information appliance 400. Clearly the cost (ie. 426) of the information appliance 400 to the consumer can be offset by the revenue 424 received by the manufacturer 410 from the advertiser 414 in respect of advertising material 442 loaded onto the information appliance 400. This counter balancing effect between the manufacturing cost 428 of the information appliance 400, and the revenue 424 from the advertiser 414 in respect of the advertising material 442 included in the sale of the information appliance 400, can significantly reduce the purchase price 426 of the information appliance, while maintaining a desired level of profit 436 for the manufacturer 410.

The previous description is directed towards one aspect of the business system, namely the initial sale of the information appliance 400 by the manufacturer 410 to the consumer. This aspect incorporates countervailing forces between the information appliance manufacturing cost 428, the desired profit 436 from information appliance manufacture, the advertising revenue 424 associated with the initial advertising 442, and the information appliance price 426 to the consumer.

Another aspect of the information appliance business system is shown in the lower half of FIG. 4. In this aspect, a software developer 418 provides an upgrade software package 446, the developer 418 incurring a development cost depicted by a dashed arrow 432. The desired profit level is depicted by a dashed arrow 438. The advertiser 414 incorporates new advertisements 448 into the software upgrade package 446 by purchasing advertising space in the context of the upgrade software.

The software developer 418 supplies the software upgrade 446 as depicted by an arrow 404, to the information appliance 400, or rather to the owner thereof (not shown). The advertiser 414 has concurrently provided updated advertisements 448 to the information appliance as depicted by arrow segments 416, 408. Revenues 430 are received by the software developer 418 from the advertiser 414 in respect of the sale by the software developer 418 to the advertiser 414 of advertising space in the context of the software upgrades 446. These revenues 430 offset the cost 432 of developing the upgraded information appliance application 446, thereby allowing the software developer 418 to provide the upgrades 446, as depicted by an arrow 404, at a reduced cost 434 to the consumer.

Clearly the counter balancing forces between the advertising revenue 430, the desired profit level 438, and the cost of the software upgrade development 432 represents an intimately coupled business relationship between the information appliance owner, the advertiser 414, and the software developer 418. Particularly given the convergence of information and telecommunication technologies, the process loops between information appliance 400, advertiser 414, and software developer 418 can become extremely mechanised. The advertising information 448 can flow from the advertiser 414 to the software developer 418 electronically, and the corresponding revenue 430 can similarly be transmitted electronically. Similar comments applying to provision of software 446 to the information appliance owner, and to resultant payment 434 therefore.

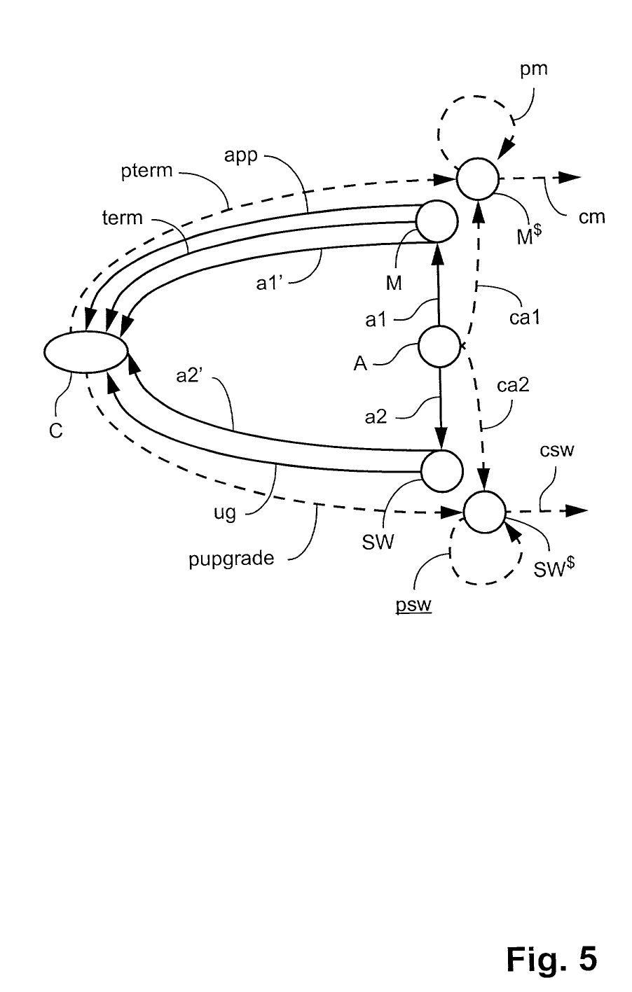

FIG. 5 shows a more abstract representation of the business system depicted in FIG. 4, emphasising the closely coupled interactive dependencies of the system. The figure shows a consumer “C”, a information appliance manufacturer “M”, an advertiser “A”, and a software developer “SW”. Associated with the manufacturer M and the software developer SW, are associated financial entity abstractions thereof, namely “M^{$}”, and “SW^{$}” respectively.

The manufacturer M manufactures an information appliance at an outgoing cost depicted by a dashed arrow “cm”, a desired profit level being designated by a re-entrant dashed arrow “pm”. The manufacturer M sells the information appliance to the consumer C, the transfer of the information appliance being represented by the arrow “term”. In consideration thereof, the consumer C pays an amount to the manufacturer M, the payment being depicted by a dashed arrow “pterm”. The manufacturer M sells advertising space to the advertiser A, the advertiser providing the manufacturer with a first batch of advertising material depicted by an arrow “a1”. The advertiser A pays the manufacturer M for this advertising space, this payment being depicted by a dashed arrow “ca1”. The manufacturer M provides, with the information appliance, an application which runs on the information appliance, the provision of the application being depicted by an arrow “app”. Furthermore, the manufacturer M incorporates the first set of advertising material al into the information appliance, this incorporation being depicted by the arrows a1, and “a1′”.

The aforementioned description is directed towards the system interaction for the upper part of the figure, ie the interactions relating to the manufacture and sale of the information appliance, and the various payments and incorporation of advertising material therein. The dynamics of this aspect of the business system can be clearly seen by considering the financial entity abstraction M^{$} under a condition of financial equilibrium. In this situation, the various dashed arrows which enter and exit the circle M^{$} can be represented by the following mathematical equation:

pterm=cm+pm−ca1 [1]

where the various terms in the equation have the meanings provided in the aforementioned description. Assuming that the manufacturing cost cm and the desired profit level pm are fixed, the manufacturer M attempts to maximise the advertising revenue cal, which has the effect of minimising the terminal cost pterm to the consumer C.

Turning back to FIG. 5, this time focussing on the lower half of the diagram, the software developer SW develops a software upgrade at a cost, and an associated desired profit level, depicted by dashed arrows “csw” and “psw” respectively. The software developer SW provides the upgrade software to the consumer C as depicted by an arrow “ug”. The consumer C in the most general case pays an upgrade price for this software, this payment being depicted by a dashed arrow “pupgrade”. The software developer SW sells advertising space to the advertiser A, who provides a second set of advertising material “a2” to the software manufacturer SW. The advertiser A pays the software developer SW an advertising space cost “ca2”.

The dynamics of this aspect of the business model can be understood by considering the financial entity abstraction “SW^{$}”. When considered in equilibrium, and having particular regard to the various dashed arrows entering and exiting SW^{$}, the system interaction can be described mathematically by the following equation:

pupgrade=csw+psw=ca2 [2]

The software developer attempts to minimise the cost of upgrades to the consumer C, and if it is assumed for the sake of simplicity that development cost csw and profit level psw are fixed, this requires that the advertising space charge ca2 be increased. In the context of software development and upgrades, it is possible to increase the advertising space cost ca2 to the point where the upgrade cost to the consumer C is zero.

Although the aforementioned business system descriptions have assumed fixed manufacture and/or development costs, and fixed profit levels, the interactive relationships between the various costs is valid even if all items are allowed to vary. In the final analysis the described business model is predicated upon minimising the cost of the VIDT and the software upgrades to the consumer C by maximising the revenues ca1 and ca2 from sale of advertising space.

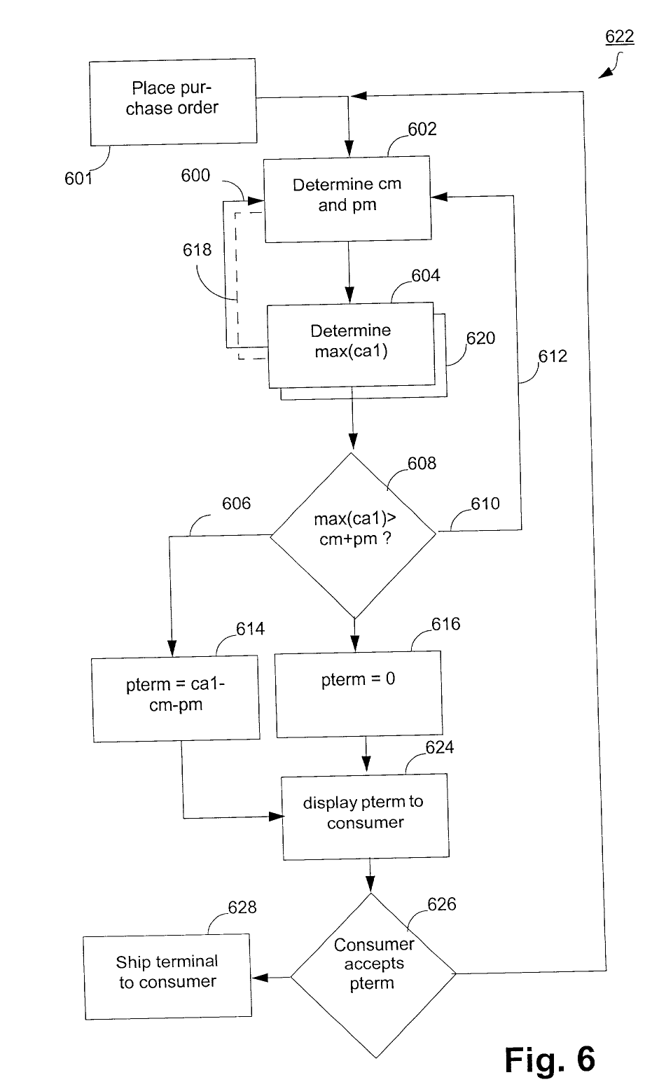

FIG. 6 shows a block diagram representation of a process for reducing the cost of an information appliance to a consumer C when a order is placed by the consumer C with the manufacturer M. In a first step 601, having regard to the variables defined in relation to FIG. 5, a consumer C places an order with the manufacturer M for the purchase of an information appliance. In a following step 602, the manufacturing cost cm and desired profit level pm are determined by the information appliance manufacturer M. In a following step 604, the manufacturer M determines the maximum revenues cal obtainable from sale of advertising space to a plurality of advertisers. The process 622 then iterates, as shown by an arrow 600 and a dashed arrow 618 (the latter depicting the “hidden” advertisers alluded to in the cascade of rectangles 604, 620), the feedback loop between the steps 602 and 604 depicting a preferred negotiating process between the manufacturer M and the plurality of advertisers.

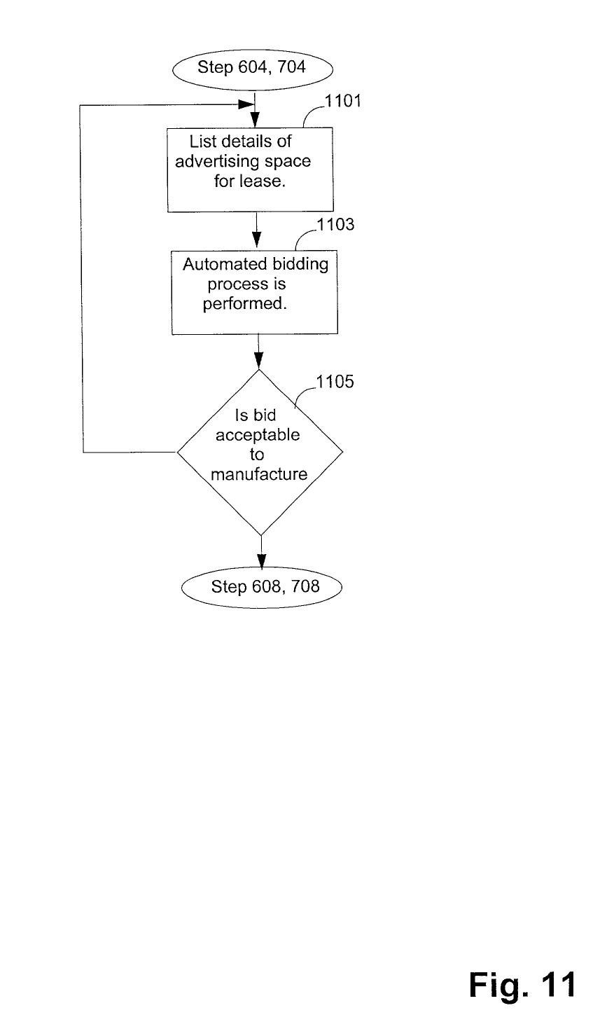

FIG. 11 is a flow chart 1100 showing the preferred negotiation process. The preferred negotiation process is essentially an auction process. In an initial step 1101, the manufacturer M lists particular advertising space for lease. The details of the advertising space are preferably listed on a Web page associated with the manufacturer M along with a starting price or current high bid price associated with the advertising space and a deadline for the negotiation process to end. The details of the advertising space include the period over which the advertising space is available for lease and a consumer profile of the consumer requesting the terminal. The period over which the advertising space is available for lease is preferably defined by a predicted purchase and delivery date of the information appliance and the date that the particular information appliance will be due for installation of a software upgrade, as will be explained below. The consumer profile can be supplied by the consumer C, at step 1101, using an on-line question and answer process. In the following step 1103, in response to the manufacturer M listing the advertising space, an advertiser A can bid on-line based on the current high bid until the negotiation process deadline. Alternatively, instead of the advertiser A bidding on-line, the advertiser A can enter the maximum price that the advertiser A is willing to pay for the space, the quantity of advertising space (i.e. if more than one parcel of advertising space is available for sale) and a preferred shipping option. Any known bidding application can be used by the advertiser A to monitor the negotiation process, and place bids on behalf of the advertiser A, when the advertiser A is not on-line. The maximum revenues cat obtainable from sale of the advertising space is reflected by the highest bid at the deadline (i.e. the close of the auction). At the next step 1105, if the manufacturer M does not accept the highest bid then the process returns to step 1101 and the manufacturer M can re-list the advertising space for sale resulting in steps 1101 to 1105 being repeated possibly at a later date. Otherwise, the negotiating process of flow chart 1100 concludes. It will be appreciated that any conventional auction method can also be used to determine the maximum revenues cat obtainable from sale of the advertising space.

Once the negotiation process has concluded, a following step 608 tests whether the maximised advertising revenue cal exceeds the sum of the manufacturing cost cm and the profit level desired pm. The manufacturer M can re-list (represented by branch 612) the advertising space for sale if the conditions of step 608 are not met. In the event that the advertising revenue does, in fact, exceed the manufacturing cost cm and the profit level desired pm costs, then a step 616 indicates that the terminal cost pterm to the consumer C is zero, indicating that the consumer C receives the information appliance at no charge, since all costs have been fully subsidised by advertising revenues. Alternately, if the advertising revenues are insufficient to fully subsidise the cost of the information appliance, then a step 614 shows that the terminal cost pterm to the consumer C is equal to a difference between the advertising revenue ca1, and a sum of the manufacturing cost cm and desired profit level pm. In the following step 624, pterm is displayed to the consumer C. The process continues at the next step 626, where if the consumer C does not accept the terminal cost pterm, then the process returns to step 601. Otherwise, in the following step 628, the terminal is shipped to the purchasing consumer C according to the consumer's preferred shipping option and the process of FIG. 6 concludes.

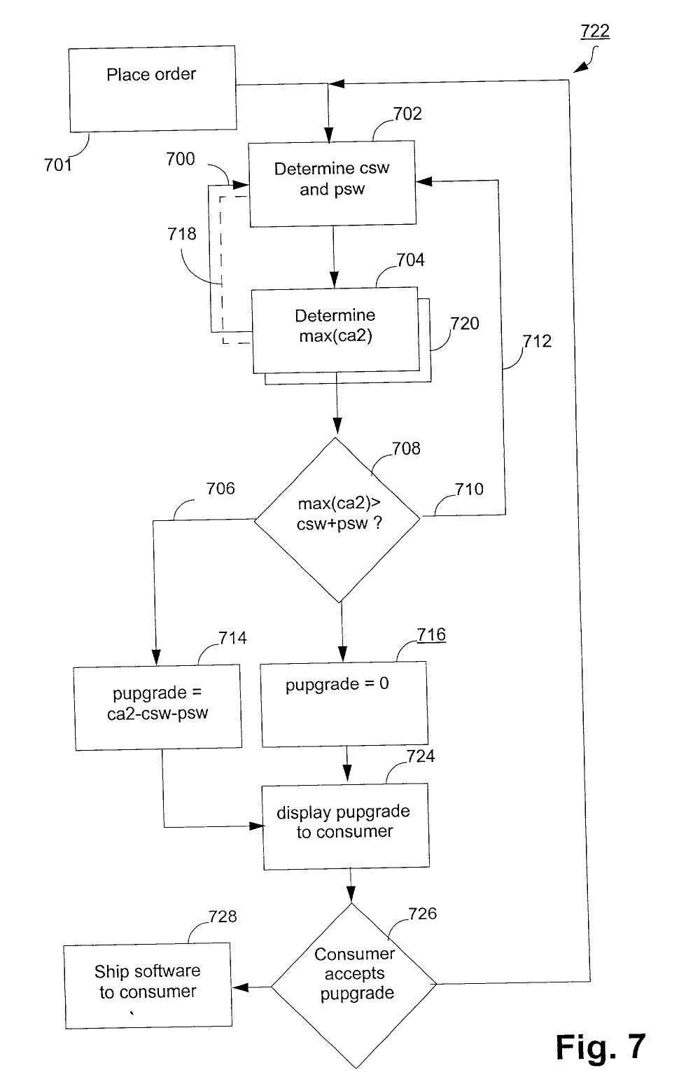

FIG. 7 shows a block diagram representation 722 by which a price paid by a consumer C for a software upgrade is minimised according to the preferred embodiment, each time the software for a particular terminal is upgraded. In an initial step 701, a software upgrade is flagged to the consumer C by the manufacturer M and the consumer C requests the software upgrade from the software developer SW. In a following step 702, a software developer determines a development cost csw for a software upgrade, and a desired profit level psw associated therewith. Thereafter, in a step 704, the software developer SW negotiates with a number of advertisers 704, . . . , 720 in order to maximise advertising revenue ca2 which can be derived from a sale of advertising space sold in the context of the new software upgrade. This negotiation process is performed in accordance with the preferred negotiation process described above, where in steps 702 and 704, the parties of the negotiation process are the software developer SW and the plurality of advertisers. Once again the negotiation process is iterative, as depicted by the arrow 700 and the dashed arrow 718. The maximum revenues ca2 obtainable from sale of the advertising space is reflected by the highest bid at a set deadline (i.e. the close of the auction), the software developer SW can then accept the bid and the negotiation process concludes. The negotiation process of flow chart 1100 is repeated each time a software upgrade is required for a particular terminal.

After the negotiation process concludes, the process 722 is directed to a testing step 708, where the now maximised advertising revenue ca2 is tested against an aggregate of the software development cost csw and the desired profit level psw. In the event that the advertising revenue ca2 exceeds these cost values, then the process 722 is directed to a step 716 which indicates that the price “pupgrade” of the software upgrade is zero. This means that the consumer C receives the software upgrade free of charge, all costs having been subsidised by advertising revenue associated with sale of advertising space in the software upgrade. Alternatively, if the advertising revenues are insufficient to cover all costs, the process 722 is directed in accordance with an arrow 706 to a step 714, which shows that a cost “pupgrade” paid by the consumer C for the software upgrade is equal to a difference between the advertising revenue ca2 and the aggregate of software development cost csw and desired profit level psw. In the following step 724, pupgrade is displayed to the consumer C. At the next step 726 if the consumer C does not accept the upgrade cost pupgrade, then the process returns to step 701. Otherwise, in the following step 728, the software upgrade is shipped to the purchasing consumer according to the consumer's preferred shipping option and the process of representation 722 concludes. In this case, the shipping options can include the upgrade software being supplied to the consumer C on a computer readable medium, including the storage devices described below, for example. The software can also be down loaded into the particular terminal of the consumer C over the Internet or other similar network as described above.

FIGS. 4 and 5 illustrates the close interactive coupling between the information appliance manufacturer, the consumer, the advertiser, and the software developer. This is emphasised in the system abstraction provided in FIG. 5. With the convergence of communications and computers, as previously noted, FIG. 5 can be implemented by manual, or automatic procedures, in which computer based processing performs, or assists with the performance of some, or all of the processes described in relation to FIGS. 6 and 7.

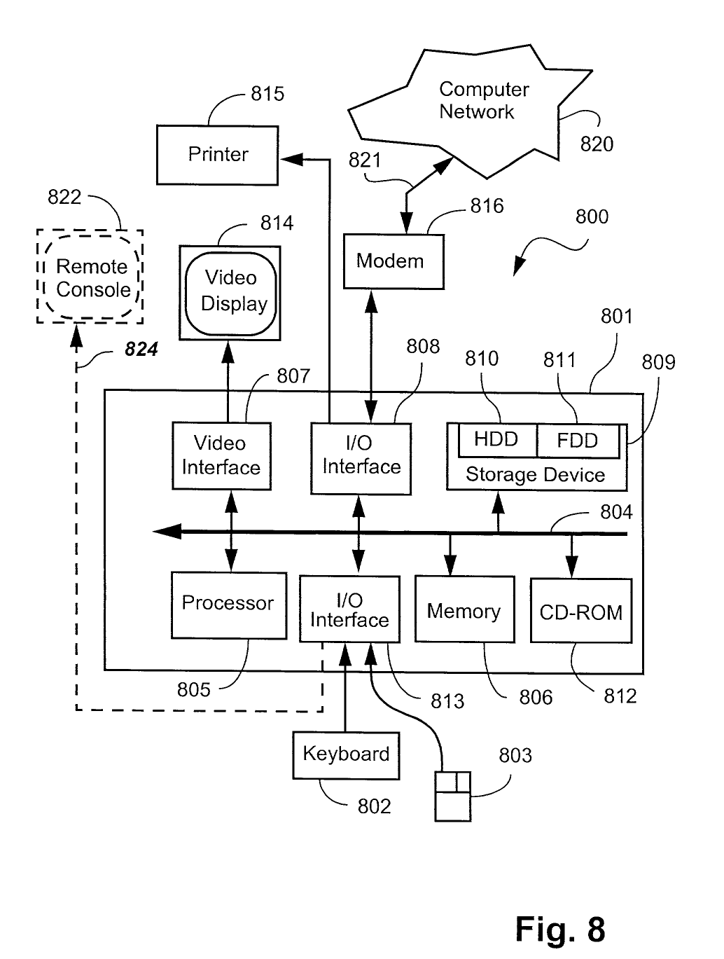

Regard is now had to one processing node of such an automated system. The node can either be a freestanding processing node in relation to FIG. 5, where all other processes are performed manually, or alternatively, can be one of many processing nodes in a more automated version of the system in FIG. 5. The method of counter balancing information appliance manufacture and/or software development costs against advertising revenue in a closed loop system can be practiced using a conventional general-purpose computer system 800, such as that shown in FIG. 8, for the aforementioned processing nodes, or alternatively, using a display console 822 in conjunction with the “remote” PC 800, as has been described in relation to FIG. 3 for the nodes. The display console 822 and its connection 824 are depicted in dashed lines to distinguish them from the “freestanding” PC 800. In this figure, the processes of FIGS. 6 and 7 may be implemented as software, such as an application program executing within the computer system 800. In particular, the steps of the method of counter balancing information appliance manufacture and/or software development costs against advertising revenue in a closed loop system are effected by instructions in the software that are carried out by the computer.

The software may be divided into two separate parts; one part for carrying out counter balancing information appliance manufacture and/or software development costs against advertising revenue in a closed loop system methods, and another part to manage the user interface between the latter and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for counter balancing information appliance manufacture and/or software development costs against advertising revenue in a closed loop system in accordance with the embodiments of the invention.

The computer system 800 comprises a computer module 801, input devices such as a keyboard 802 and mouse 803, output devices including a printer 815, a display device 814 and/or, a remote console 822. A Modulator-Demodulator (Modem) transceiver device 816 is used by the computer module 801 for communicating to and from a communications network 820, for example connectable via a telephone line 821 or other functional medium. The modem 816 can be used to obtain access to the Internet, and other network systems, such as a Local Area Network (LAN) or a Wide Area Network (WAN).

The computer module 801 typically includes at least one processor unit 805, a memory unit 806, for example formed from semiconductor random access memory (RAM) and read only memory (ROM), input/output (I/O) interfaces including a video interface 807, and an I/O interface 813 for the keyboard 802, mouse 803 and remote console 822, and optionally a joystick (not illustrated), and an interface 808 for the modem 816. A storage device 809 is provided and typically includes a hard disk drive 810 and a floppy disk drive 811. A magnetic tape drive (not illustrated) may also be used. A CD-ROM drive 812 is typically provided as a non-volatile source of data. The components 805 to 813 of the computer module 801, typically communicate via an interconnected bus 804 and in a manner which results in a conventional mode of operation of the computer system 800 known to those in the relevant art. Examples of computers on which the embodiments can be practised include IBM-PC's and compatibles, Sun Sparcstations or alike computer systems evolved therefrom.

Typically, the application program of the preferred embodiment is resident on the hard disk drive 810 and read and controlled in its execution by the processor 805. Intermediate storage of the program and any data fetched from the network 820 may be accomplished using the semiconductor memory 806, possibly in concert with the hard disk drive 810. In some instances, the application program may be supplied to the user encoded on a CD-ROM or floppy disk and read via the corresponding drive 812 or 811, or alternatively may be read by the user from the network 820 via the modem device 816. Still further, the software can also be loaded into the computer system 800 from other computer readable medium including magnetic tape, a ROM or integrated circuit, a magneto-optical disk, a radio or infrared transmission channel between the computer module 801 and another device, a computer readable card such as a PCMCIA card, and the Internet and Intranets including email transmissions and information recorded on websites and the like. The foregoing is merely exemplary of relevant computer readable mediums. Other computer readable mediums may be practiced without departing from the scope and spirit of the invention.

### INDUSTRIAL APPLICABILITY

It is apparent from the above that the embodiment(s) of the invention are applicable to the information appliance manufacturing, and information appliance software development industries.

The foregoing describes only one embodiment/some embodiments of the present invention, and modifications and/or changes can be made thereto without departing from the scope and spirit of the invention, the embodiment(s) being illustrative and not restrictive.

The claims defining the invention are as follows:

1. An information appliance, comprising:
a display incorporating an advertising display area disposed within a working display area, wherein display of advertising information within said advertising display area is independent of a non-advertising application being run on the information appliance, and wherein upgrade software for upgrading said non-advertising application and for providing said advertising information, has an upgrade price for purchase by an owner of the information appliance, said upgrade price being dependent upon a difference between an advertising cost for an amount of said advertising display area and an upgrade cost for producing said upgrade software, and wherein said upgrade price is dependent on said advertising cost.

2. An information appliance according to claim 1, wherein said upgrade price is reduced by an amount equal to said advertising cost and wherein said upgrade cost includes a profit, respectively.

3. An information appliance according to claim 1, wherein said amount of said advertising cost is determined in accordance with at least one of (i) viewing time, and (ii) area within said advertising display area, respectively.

4. An information appliance, comprising:
an advertising display area disposed within a working display area, wherein display of advertising information in said advertising display area is independent of a non-advertising application being run on the information appliance, said advertising information being disposed within the information appliance and said advertising display area being provided in the context of said non-advertising application, and wherein said information appliance has a terminal price for purchase by a consumer, said terminal price being dependent upon a difference between an advertising cost to an advertiser for an amount of said advertising display area and a manufacturing cost of said information appliance, said terminal price being dependent on said advertising cost.

5. An information appliance according to claim 4, wherein said terminal price is reduced by an amount equal to said advertising cost, respectively.

6. An information appliance according to claim 4, wherein said manufacturing cost includes a profit, respectively.

7. A method of reducing a price of an information appliance having a display incorporating an advertising display area disposed within a working display area of the information appliance, said method comprising the steps of:
determining a manufacturing cost of the information appliance;
selling a portion of the advertising display area to an advertiser for an advertising cost;
determining a terminal price dependent upon a difference between said advertising cost and said information appliance manufacturing cost; and
adjusting said advertising cost to decrease said terminal price.

8. A method of reducing a price of a software upgrade for an information appliance, said information appliance having a display incorporating an advertising display area disposed within a working display area of the display, said method comprising the steps of:
selling a first use of the advertising display area to a first advertiser for a first advertising cost, said first use being to display a first set of advertising material during a period commencing with a first use of the appliance by a user after purchase of the appliance, and terminating with a last use of the appliance by the user prior to installation of a software upgrade;
determining a development cost of the software upgrade;
selling a further use of the advertising display area to a further advertiser for a further advertising cost, said further use being to display a further set of advertising material during a period commencing with a first use of the appliance by a user after installation of the software upgrade, and terminating with a last use of the appliance by the user prior to installation of a further software upgrade;
determining a price of the software upgrade dependent upon a difference between at least one of (i) said first advertising cost and said further advertising cost, and (ii) said development cost; and
adjusting said further advertising cost to decrease said price of the software upgrade.

9. A method of providing, at a reduced cost to a consumer, a device with a display capable of displaying images stored in digital form, said method comprising steps of:
providing digital storage means in said device for storing advertisement information;
storing in said digital storage means advertisement information paid for by at least one advertiser;
configuring the device to at least display said advertising information; and
providing said device to said consumer at a cost subsidised by said advertising payment.

10. A method according to claim 9, whereby said device displays said advertising information independently of other functions of the device.

11. A method according to claim 9, whereby said device displays at least a portion of said advertising information at all times it is operational.

12. A method of providing, at no cost to a consumer, software upgrades to a device with a display capable of displaying images stored in digital form, said display incorporating an advertising display area disposed within a working display area of said display, said method comprising steps of:
developing upgrade software which is configured to provide advertising information;
selling a portion of said advertising display area to at least one advertiser; and
providing, free of charge, said upgrade software to consumers, said free of charge provision being subsidised by said selling of said portion of said advertising display area.

13. A method according to claim 12, whereby said device displays advertising information independently of other functions of the device.

14. A method according to claim 12, whereby said device displays at least one advertisement at all times it is operational.

15. A method of providing software upgrades to a device configured to display advertisements independently of other functions of the device, said providing being at a reduced cost to a consumer, said method comprising steps of:
producing upgrade software which includes provision for advertising space;
selling said advertising space to at least one advertiser; and
providing said software upgrades to a consumer at cost subsidised by selling said advertising space.

16. A method of providing a software upgrade to a device configured to display an advertisement at all times the device is operational, said providing being at a reduced cost to a consumer, said method comprising steps of:
producing said upgrade software which is configured to provide advertisements for display on said device;
selling advertising time for display of said advertisement, to at least one advertiser; and
providing said software upgrade to a consumer at a cost subsidised by said advertising sale.

17. A computer readable medium having a program recorded thereon, said program comprising a plurality of software modules adapted for interactive operation on at least one computer platform, said program being adapted to reduce a price of a software upgrade for an information appliance, said program comprising:
first determining code for determining a development cost of the software upgrade, an advertising display area being disposed within a working display area of the information appliance;
selling code for selling a portion of the advertising display area to an advertiser for an advertising cost;
second determining code for determining a price of the software upgrade dependent upon a difference between said advertising cost and said development cost; and
adjusting code for adjusting said advertising cost to decrease said price of the software upgrade.

18. A computer readable medium having a program recorded thereon, said program comprising a plurality of software modules adapted for interactive operation on at least one computer platform, said program being configured to reduce a price of an information appliance, said program comprising:
first determining code for determining a manufacturing cost of the information appliance, an advertising display area being disposed within a working display area of the information appliance;
selling code for selling a portion of the advertising display area to an advertiser for an advertising cost;
second determining code for determining a terminal price dependent upon a difference between said advertising cost and said information appliance manufacturing cost; and
adjusting code for adjusting said advertising cost to decrease said terminal price.

19. A computer readable medium having a program recorded thereon, said program comprising a plurality of software modules adapted for interactive operation on at least one computer platform, said program adapted to providing, at a reduced cost to a consumer, a device with a display capable of displaying images stored in digital form, said program comprising:
first providing code for providing a digital storage area within said device for storing advertising information;
storing code for storing in said digital storage space advertisement information paid for by at least one advertiser;
configuring code for configuring the device to at least display said adverting information; and
second providing code for providing said device to said consumer at a cost subsidised by said advertising payment.

20. A computer readable medium having a program recorded thereon, said program comprising a plurality of software modules adapted for interactive operation on at least one computer platform, said program adapted to provide, at no cost to a consumer, software upgrades to a device with a display capable of displaying images stored in digital form, said program comprising:
developing code for developing upgrade software which is configured to provide advertising information;
selling code for selling said advertising display area for the display of said advertising information to at least one advertiser; and
providing code for providing, free of charge, said software upgrade to consumers, said free of charge provision being subsidised by said selling of said advertising display area.

21. A computer readable medium having a program recorded thereon, said program comprising a plurality of software modules adapted for interactive operation on at least one computer platform, said program adapted to provide software upgrades to a device configured to display advertisements independently of other functions of the device, said providing being at a reduced cost to a consumer, said program comprising:
producing code for producing upgrade software which is configured to provide an advertising display area;
selling code for selling said advertising display area to at least one advertiser; and
providing code for providing said software upgrades to a consumer at a cost subsidised by said sale of said advertising display area.

22. A computer readable medium having a program recorded thereon, said program comprising a plurality of software modules adapted for interactive operation on at least one computer platform, said program adapted to provide a software upgrade to a device configured to display an advertisement at all times the device is operational, said providing being at a reduced cost to a consumer, said program comprising:
producing code for producing said upgrade software which is configured to provide an advertising display area;
selling code for selling said advertising display area to at least one advertiser; and
providing code for providing said software upgrade to a consumer at a cost subsidised by said sale of said advertising display area.

23. A method of determining a value for providing advertising space to an advertiser, said advertising space being part of an intended software upgrade for an information appliance which is one of a plurality of information appliances, said method comprising steps of:
determining a consumer exposure to current advertising in said plurality of information appliances; and
ascribing a value to said intended software upgrade dependent upon said consumer exposure.

24. A computer readable medium having a program recorded thereon, said program comprising a plurality of software modules adapted for interactive operation on at least one computer platform, said program adapted to determine a value for providing advertising space to an advertiser, said advertising space being part of an intended software upgrade for an information appliance which is one of a plurality of information appliances, said program comprising:
determining code for determining a consumer exposure to current advertising in said plurality of information appliances; and
ascribing code for ascribing a value to said intended software upgrade dependent upon said consumer exposure.

25. An information appliance comprising:
a video display having a working display area incorporating a reserved advertising display area disposed within the working display area, said reserved display area being adapted to display advertising information independently of a non-advertising application being run on the information appliance; and
input means adapted to accept a software upgrade for said non-advertising application, said software upgrade being configured to update advertising information, wherein said updated advertising information is displayed, independently of a non-advertising application being run on the information appliance, when said information appliance is operating.

26. A video information display business system for supplying an information appliance having a display incorporating an advertising display area disposed within a working display area, wherein display of advertising information within said advertising display area is independent of a non-advertising application being run on the information appliance, comprising:
upgrade software for upgrading said non-advertising application, said upgrade software having an upgrade cost and being offered to an owner of the information appliance for an upgrade price, said upgrade software being configured to provide said advertising information;
advertising cost determination means adapted to determine an advertising cost for an amount of said advertising display area to be offered to an advertiser;
upgrade price determination means adapted to determine said upgrade price dependent upon a difference between said advertising cost and said upgrade cost; and
price adjusting means adapted to adjust said advertising cost in order to decrease said upgrade price.

27. A video information display business system according to claim 26, wherein said upgrade cost includes a profit.

28. A video information display business system according to claim 26, wherein said advertising cost is determined in accordance with at least one of (i) viewing time, and (ii) area within said advertising display area.

29. A video information display business system for selling an information appliance having an advertising display area disposed within a working display area, wherein display of advertising information within said advertising display area is independent of a non-advertising application being run on the information appliance, said advertising information being disposed within the information appliance and said advertising display area being provided in the context of said non-advertising application, comprising:
information appliance selling means for offering said information appliance to a consumer for a terminal price, said information appliance having a manufacturing cost;
advertising selling means adapted to offer an amount of said advertising display area to an advertiser for an advertising cost;
terminal price determination means adapted to determine said terminal price dependent upon a difference between said advertising cost and said manufacturing cost; and
price adjusting means adapted to adjust said advertising cost to decrease said terminal price.

30. A video information display business system according to claim 29, wherein said manufacturing cost includes a profit.

31. A video information display business system according to claim 29, wherein said advertising cost is determined in accordance with at least one of (i) viewing time, and (ii) area within said advertising display area.
